(19) United States
(12) Patent Application Publication
(10) Pub. No.: US 2012/0050144 A1
(43) Pub. Date: Mar. 1, 2012

(54) Wearable augmented reality computing apparatus

(76) Inventor: Clayton Richard Morlock, Lebanon, NH (US)

(21) Appl. No.: 13/218,669

(22) Filed: Aug. 26, 2011

Related U.S. Application Data
(60) Provisional application No. 61/402,224, filed on Aug. 26, 2010.

(51) Int. Cl. G09G 5/00

(52) U.S. Cl. 345/8

(57) ABSTRACT

A wearable augmented reality computing apparatus with a display screen, a reflective device, a computing device and a head mounted harness to contain these components. The display device and reflective device are configured such that a user can see the reflection from the display device superimposed on the view of reality. An embodiment uses a switchable mirror as the reflective device. One usage of the apparatus is for vehicle or pedestrian navigation. The portable display and general purpose computing device can be combined in a device such as a smartphone. Additional components consist of orientation sensors and non-handheld input devices.

### CROSS REFERENCE TO RELATED APPLICATIONS

This application is based on U.S. provisional application Ser. No. 61/402,224, filed on Aug. 26, 2010.

### STATEMENT REGARDING FEDERALLY SPONSORED RESEARCH OR DEVELOPMENT

Not Applicable

### FIELD OF THE INVENTION

This invention relates generally to the field of augmented reality and navigation devices and more specifically to a wearable augmented reality computing apparatus.

### BACKGROUND OF THE INVENTION

An augmented reality device consists of means for a viewer to see a view of reality with additional spatially related objects pertinent to the scene superimposed on the view of reality. A heads-up display is a means to display information in the periphery of the field of view of the user such that the user is not required to glance away from the primary view—for example when driving a car. You see heads-up displays in the form of projection of information such as speed and direction of travel on car windshields in production cars such as the Chevrolet Corvette and some high-end BMW's.

In order to implement augmented reality applications, sensors and software that can determine the location and direction of view of a user are required in order to determine place information at relevant locations in the view. In a navigation scenario, a semi-transparent rendering of the centerline of the proposed route which overlays the route in the view of reality is an example of augmented reality. Another example of augmented reality is a display of information concerning a piece of art in an art museum when the user is viewing a particular piece of art—the information is relevant to the view and the piece of art being looked at is determined by the location of the viewer and the direction of the viewers gaze and from a digital map describing where particular pieces of are are located.

The utility of an augmented reality device is much enhanced if the device is portable, self contained, wearable and capable of hands-free operation. Apparatus currently exist that meet this criteria in the prior art, but there are several drawbacks with current devices:
most devices are typically custom built specifically for heads up or augmented reality applications and often have complex optical components
these device are very expensive
typically the “reality” being viewed is a video image from a camera looking in the direction of the user which both reduces the field of view and limits resolution (see US 2010/0079356 A1).

To avoid the high cost of custom products, typically the view of reality is actually a camera image taken from a camera near the viewers eyes and taken in the direction of viewer's gaze. This both limits the field of view and resolution. In addition, the superposition of a camera image with augmented information is more compute intensive and depending on the portable computing device which generates the combined image, there may be a discernible lag in the display (not real-time).

An alternative heads up display device display is a small non-transparent screen which takes up part of the filed of view. The basic issue with this type of device is that obscures the field of view and is not capable of superposition—only a view in proximity to reality.

Transparent liquid crystal displays (LCD) exist which allow superposition of information on reality, but these devices have issues of low resolution and insufficient light intensity to see augmented information in full sunlight.

Switchable mirrors are known. They have the property where they can be switched from total transmission of light to total reflection at high switching frequencies. Certain classes of switchable mirrors have addressable pixels that can be switched individually into a reflective or transmissive mode.

Another product on the market is referred to as a semi-transparent mirror or teleprompter glass or a beam-splitter consists of glass that has a reflective coating on one side, and the other side has an anti-reflective coating.

In order to project information for an augmented reality application, the location of the viewer and the orientation of the viewer's gaze must be known precisely. Determination of the view orientation can be done with a variety of sensors in various configurations known in the prior art. Examples of sensors used for compass orientation are GPS (using multiple measurements over time to determine direction of travel, when the user is in motion), or a digital compass. Accelerometers can be used to detect changes in orientation and speed. By combining information from a digital compass and accelerometers, a form of relative positioning can be determined. This is known as dead reckoning where you measure speed and direction of travel away from a know location. Tilt meters measure changes in the orientation of the sensor relative to the gravitational pull.

To adequately track the view orientation of a user, at a minimum, the position of the head of the user must be known. Yet a more accurate measurement, would be the view orientation of the viewer's eyes. To determine the orientation of the head with sensors, the sensors must either be mounted on the head or remotely detect the head position relative to a fixed reference. Obviously remote sensors are not conducive in a mobile environment, such as a pedestrian walking. Typically to discern the orientation of the eyes, video imagery is used as a means to track the irises.

Most new smartphones have all the location and orientation sensors necessary in order to calculate the viewers prospective and orientation (for head position only, not direction of gaze). It is known in the art to track the position of the head and location of the user with sensors in a smartphone or similar device.

To make an augmented reality wearable computer apparatus safe to use, input to the apparatus should not require that the eyes ever need to leave forward view such as the road or the sidewalk while navigating. This includes while inputting instructions to control an application. There are several different existing technologies for hands-free input in various forms of maturity. Communication to the computing device via either wired or wireless means. Input devices other than orientation sensors do not have to be affixed to the head of the user.

The following list are examples of input devices and should not be construed as being an exhaustive list:
Text to speech and speech to text is a well know discipline and will not be discussed here. Standards techniques that are readily available can be applied here.
There are a couple forms of hand tracking currently emerging:
Actual typing by tapping one finger against another—activating glove based sensors, and;
Monitoring of hand motion.
Commercial devices for monitoring alpha wave emission from various locations in the brain are currently on the market. This falls under the domain of biofeedback, so you would probably have to train your brain (much as you train yourself to type) in order to consistently control an application.
Facial expression can also be tracked by image analysis where images could come from the same video source as a camera which is used to track eye position.
The inertial sensors that will be used to monitor view orientation could also be used as an interface. A rapid up and down nod of the head, for example, could be used to select a menu item; a left to right nod, could be used to scroll a menu. This is basically the Wii™ controller mounted to the wrist or held in a hand. The user would see buttons on the screen and you would manipulate the hand position to select various buttons.
Research of video interpretation of sign language has shown that this is a rapid means of input. In addition to video input, a 3D glove could also be adapted to interpret sign language. As sign language required both hands, this would not be suitable for driving. However, a single hand version might be perfected for a limited number of commands.
It is possible to very accurately track the position of the eye—the direction of gaze. However additional hardware is needed for this—usually some type of imaging device and software to determine the eye locations. If a menu is displayed, these type of system can track what menu item the eye is centered on and for how long and this could be used to control a device.

Location sensors can be GPS and similar sensors devices, track radio signals from precisely located satellites in space and come up with a location (usually expressed in degrees latitude and longitude) based on triangulation from the satellites. Both Russia and Europe are putting up location tracking satellite systems.

Triangulation of radio signals is a well know method for determination of location. Signals that can be utilized include—from mobile phone towers, TV transmitters and Wifi Hubs. Although these methods typically do not result in as precise of location as available from a GPS location measurement, they do not generally rely on line-of-site measurements and are therefore useful. In addition, the functionality is built into several smart phones.

Inertial guidance systems use a suite of sensors to monitor acceleration and direction of travel to determine a position relative to a known initial position. These were commonly used in airplanes, prior to the GPS system being initiated. Smart phone and other device have all the initial makings of an inertia guidance system and there is software available commercially for this purpose. As present location based on an inertial guidance system is relative to an initial measurement using other means, all positions determined with an INS will accumulate error with each successive reading of sensors and the calculation of position. Based on accelerometers oriented at 90 degrees to one another, the velocity at any given time can be calculated. By knowing the velocity (speed and direction) then, given elapsed time, the position can be determined. By using either a magnetometer (as a digital compass) or a gyroscope, the direction can be determined.

The suite of sensors that make up the INS needs to be mounted on the head of the user so that it can be used to accurately determine the orientation of the filed of view. In this position it could also be used as a user input device by monitoring rapid head movements.

All of the above location determining means, could be used in tandem. A GPS could be used for an initial location and a INS for subsequent relative positions. Because all of these device have different accuracies and precisions, then well known techniques such as Kalman filtering could be employed to utilize all of these measurements devices in the most effective means.

Additional sensors can also be used to enhance an apparatus. Typically a camera is included in a smartphone or PDA. This camera can be utilized via image processing software for object recognition. However if the smartphone is to be mounted such that the display is facing downward, then the camera would face upwards. In order to capture images from within the view area, a mirrored prism can be mounted above the lense and oriented such that light is gathered from the view area. This then can be used to detect objects of importance for orienting the virtual objects on reality. For example if the application was to repair an engine, the air cleaner on the engine could be optically identified and its position in field of view determined, so that diagrams and instructions for fixing the engine could be placed in the proper location.

Although the above techniques and individual devices are known in the prior art, it is not know to combine these techniques into a single apparatus. The present invention also overcomes several of the shortcomings described in existing devices.

### SUMMARY OF THE INVENTION

The primary object of the invention is an augmented reality wearable computer apparatus that is portable and inexpensive configured to generate a view of spatially relevant objects superimposed on reality and to display pertinent information on the periphery of the view of realty. This device is usable both as heads up displays for information only or for augmented reality applications.

Another object of the invention is to utilize a switchable mirror or semi-transparent mirror as part of the display mechanism in the above apparatus.

Another object of an embodiment of the invention is the mounting of orientation and position sensors on the head of the user for determination of head and/or eye position.

Yet another object of the invention is coupling non-keyboard input devices.

Still yet another object of the invention is using off-the-shelf components inexpensively to create the apparatus incorporating devices such as a smartphone into the apparatus to be used to provide a display device, orientation and location sensors and a computing device.

Another object of the invention is routing/navigation for both pedestrian and vehicles.

In order to improve the image quality of the display of the augmented reality wearable computer, a optical device much like prescription glasses can also be used in conjunction with the display.

Yet another object of the invention is a feature to protect the user from impact and collision while wearing the apparatus.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a wearable augmented reality computing apparatus comprising: a display screen, a reflective device oriented such that a user can see the reflection from the display device superimposed on the view of reality, a head mounted harness comprising a means to hold the display and the reflective device in a position viewable by the user, and a computing device functionally connected to the portable display device configured to generate the display information to display on the portable display. The computing device is further connected to sensors to detect the orientation of the view of the user and configured to calculate the display of augmented information in order to juxapose the information on reality.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a profile view of an embodiment of the invention showing the portable display screen and the reflective device attached to a visor of a hat.

FIG. 2 is a profile view of another embodiment of the invention showing the portable display screen and the reflective device attached to a full face shield commonly used for environmental protection.

FIG. 3 is a perspective drawing of the apparatus configured in as part of protective goggles.

FIG. 4 is a profile drawing of the apparatus configured in a full face motorcycle helmet.

FIG. 5 is a profile display of the apparatus showing the reflective device with a built-in optical correction.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the present invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims. Embodiments illustrated in the figures show a combination of a display device, orientation and location sensors and a computing device contained within a single device such as a smartphone 108 or PDA. As this combination simplifies the construction of the augmented reality wearable computing apparatus, it is a preferred method. However, custom devices and/or separate components are equally viable and in some embodiments may be preferable. In which case only the display device and the sensors need be attached to the head of a user 102. The computing device can be located anywhere where it can be in wired or wireless communication with the display and the sensors.

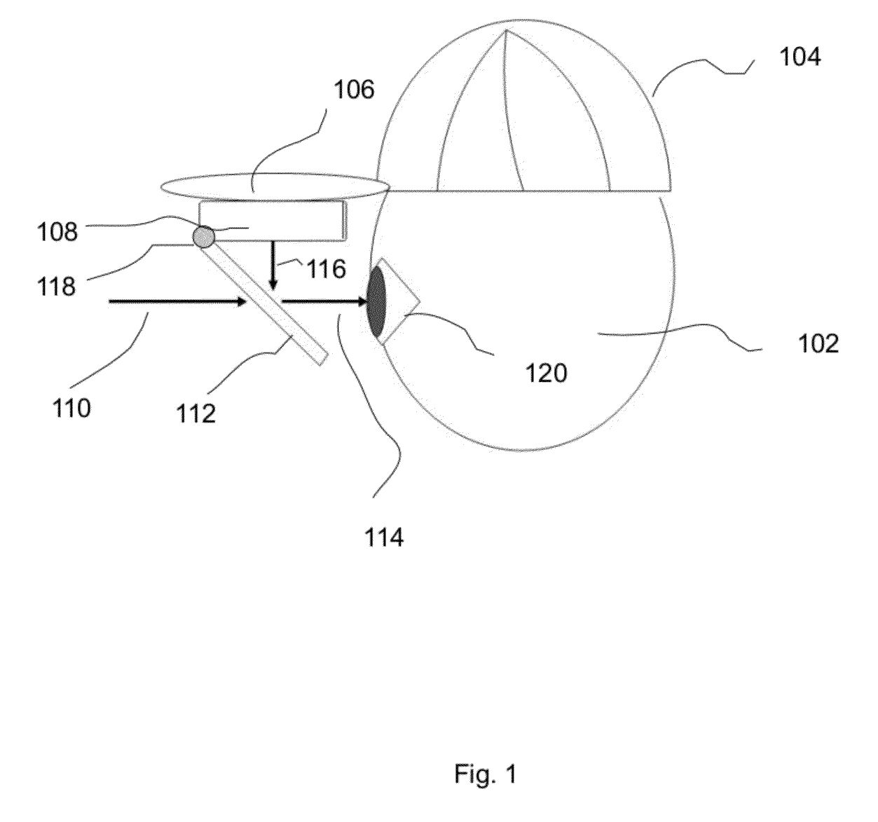

An embodiment of the present invention is shown in FIG. 1 where a wearable augmented reality computer, consists of, in this case, a combined display device, motion and location sensors and computing device, which is embodied in a device such as a smartphone or similar device 108, for example an Apple iPhone™. The smartphone 108 is affixed to the brim 106 of a hat 104 such as a baseball cap with the screen oriented in a downward position. The smart phone 108 is attached to the brim 106 via elastic strips, cable ties, Velcro™ or other means (not shown). A reflective device 112, which can be either a switchable mirror or a semi-transparent mirror (teleprompter glass), is attached to either the brim 108 or the smartphone 108 via an attachment means 118. The attachment means 118 can be a hinge made of metal or plastic and or rigid connection made of metal or plastic that holds the reflective device 112 at an angle of about 45 degrees relative to the smartphone 108 and also at an angle of 45 degree relative to the gaze 114 of the user's eye 120. If the attachment means 118 is hinged, the hinge is orient such that the reflective device 112 can be folded flat against the smartphone 116 display. The attachment means 118 and a means to attach the smartphone 108 to the rim 106 (not shown) can be combined in a single molded plastic container.

In this configuration shown in FIG. 1, reality 110 is viewed through the reflective device 112 and augmentation 116 is superimposed on reality 110 for a combined view 114 incident on the eye 120 of the viewer/user 102.

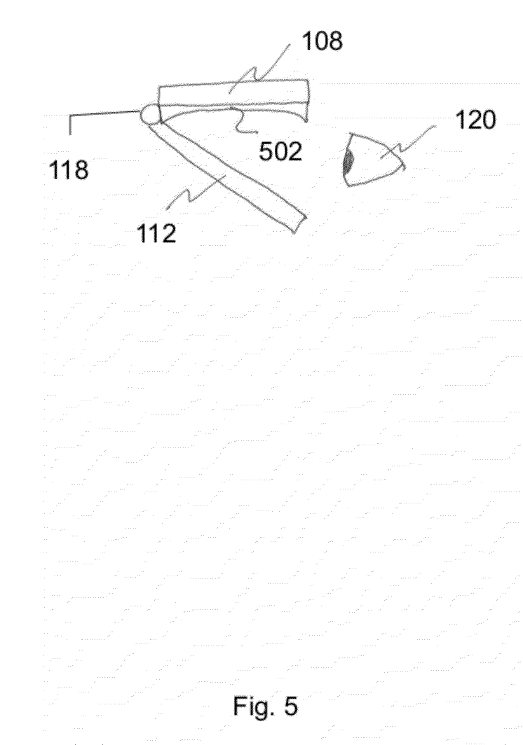

The distance from the eye 120 to the center of the reflective device 112 will vary based on the resolution of the display device (part of smartphone 108) and whether the reflective device 112 is flat or has optical focusing properties as shown in FIG. 5 (described later).

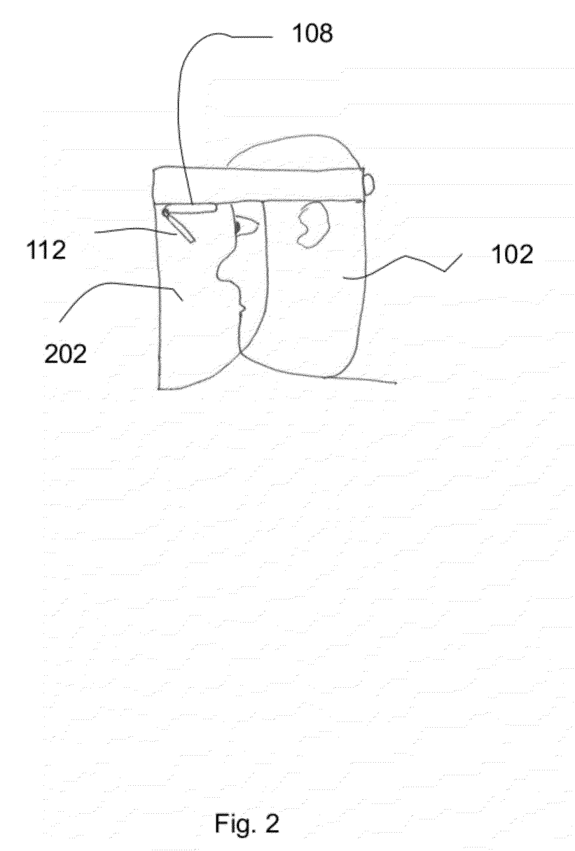

FIG. 2 is another embodiment of the augmented reality wearable computing apparatus where the cap 104 of FIG. 1 is replaced by a face shield 202 such as worn by firefighters or police. All other aspects of this embodiment are the same as in FIG. 1.

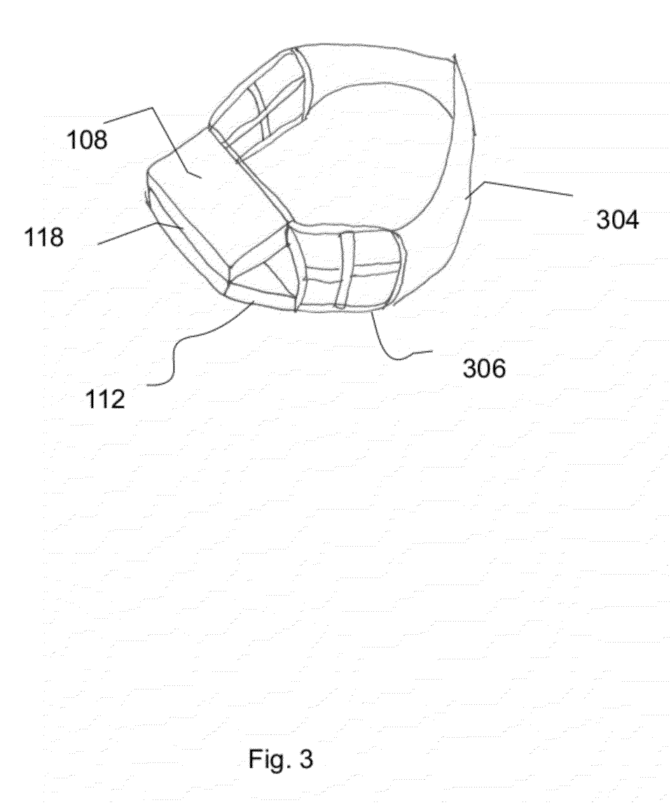

FIG. 3 is another embodiment of the augmented reality wearable computing apparatus were harness that holds the smartphone 108 and reflective device 112 consists of a wire cage 306 and head strap 304 much like eye protection worn in sporting events. The attachment means 118 can be an integral part of the wire cage 306 with plastic retaining clips (not shown) to rigidly connect the components to the wire cage 306. All other aspects of this embodiment are the same as in FIG. 1.

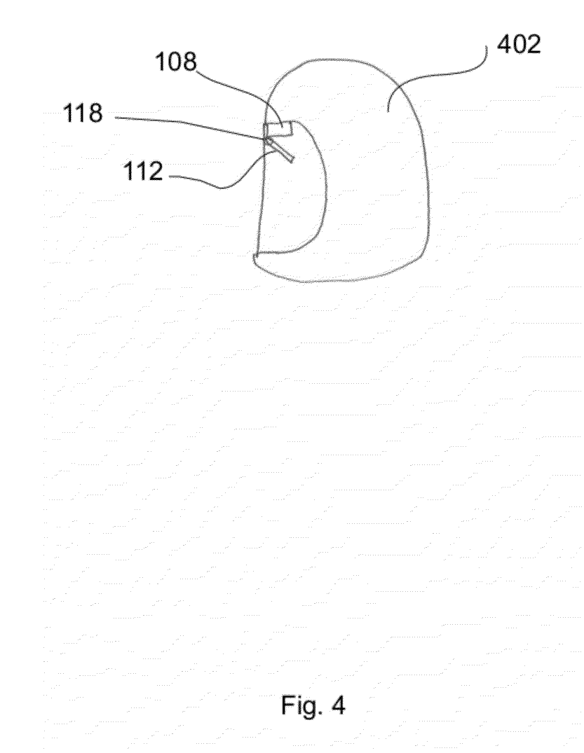

FIG. 4 is another embodiment of the augmented reality wearable computing apparatus where the cap 104 of FIG. 1 is replaced by a motorcycle helmet 402. All other aspects of this embodiment are the same as in FIG. 1.

In all embodiments of this invention, depending on the distance that the apparatus is away from the eye 120 and any issues with vision, the eye 120 may not be able to focus on the information from the display device on the smartphone 108. In order to correct for this, a concave or convex lense 502 can be placed in front of the display screen on the smartphone 108 to correct the view. The concavity or convexity of the lense 502 will be dependent on the conditions being corrected for. Alternatively the actual display image could be modified to correct the view (not shown). In order to not distort reality, the lense needs to be placed between the display of the smartphone 108 and the reflective device 112. The lense 502 could also be a fresnel lense.

All embodiments have in common that at least the display (shown as part of a smartphone 108) and the reflective device 112 are attached to a harness worn on the head and configured such that the information displayed on the display is viewable superimposed on reality. The computing device can be contained within a smartphone, a Personal digital assistant, or a personal navigation device or laptop computer or tablet computer or custom device. The display can be part of the computing device or a separate device connected via wired or wireless means.

The computing device is optionally connected to sensors which can be utilized to determine the orientation of the view of the user as described previously. These sensors can be incorporated into the computing device, if the computing device is attached to the head (such as a smartphone) or separate, once again being operatably connected via wireless or wired means. Examples of sensors include, accelerometers, a digital compass, GPS receiver, and a tilt meter. Sensors are configured to measure the orientation of the head. Additional sensors could be used to track eye motion, so not only the orientation of the head of the user is known, but also the direction and tilt of the gaze of the user.

An embodiment of the invention (not shown) is built from conventional off-the-shelf lcd or other flat panel display to display information that can be superimposed on reality. In order to do this, the display is held in place by the harness in such a manner that the display information can be transmitted onto a reflective surface with the reflection being incident on the viewers field of vision 114. FIGS. 1 thru 5 are various embodiments of how the display and reflective device 112 can be attached to head mounted harnesses. A flat panel display (which could be a smartphone 108 display) is held in place by a fastening means to the underside of a brim 106 of a hat 104, to a safety shield 202, to a safety cage 306, or to a bicycle or motorcycle helmet 402 respectively. This display is configured to display text and graphics as a mirror and inverted image such that the view from the reflective surface is properly oriented.

Sensors to determine head and eye position (if used), the display screen and the reflective device 112 must be rigidly attached to the head of the user. The reflective device 112 may be hinged at the connection 118 with or near the display screen so as it can be folded up out of the way when no in use.

As the reflective device 112 could present a safety hazard in the event of an accident causing the visor or other support means being folded down towards the face of the user, additional structural supports (not shown) (similar to a cage on safety goggles for sporting activities) can be added to the reflective device—effectively prohibiting blunt trauma to the face from abrupt contact with the reflective device. Alternatively, the reflective device could be spring loaded (not shown) such that when the visor or other support means is bent towards the face, this triggers the actuation of the spring, which folds up the reflective device into the visor or other support means 118.

The computing device is configured by means of software to display information as a mirror and inverted image. In an embodiment where the reflective surface 112 is a switchable mirror, the software controls the switching process so that the user alternately sees the reality and the information on the screen, such that the user's mind merges the two images. This generally would require a switching rate of less than 10 milliseconds (mirrored to un-mirrored; un-mirrored to mirrored).

Additional options to the augmented reality wearable computer are both audio input and output devices. Both microphone—for verbal commands and earphones for audio output can be attached to the mounting harness and function connected to the computing means via wireless or wired communications.

To allow viewing of information on the display screen in high ambient light levels, some embodiments of the invention have blinders (not shown) attached to the harness, such that the only ambient light that the user sees comes thru the reflective device 112. Ambient light can be reduced by tinting the reflective device 112 to restrict the amount of light entering the eyes.

3 dimensional effects—3d projection of superimposed information on reality can be achieved in the present invention by dividing the display screen into two images (a left eye view and a right eye view). In one embodiment, an opaque divider is placed in contact with the top of the nose of the user extending vertically bisecting the display—effectively segregating half of the display information for each eye. This configuration would work for either a semi-transparent mirror or a switchable mirror.

In another embodiment, an additional component is added to the apparatus where the user where polarized lenses (not shown) in front of the eyes (one horizontal and the other vertically oriented). The display information is then transmitted alternately in differing view for each eye using the correct polarization.

In yet another embodiment, the user wears differing color filters (not shown) in front of the eye (for example red and green) and the display offsets the display for each eye based on the filters to achieve the 3D effect.

To further reduce ambient light in full sunlight situations, blinders may need to be installed (not shown) on the side of the face which prohibit light from reaching the eyes other than through the reflective device.

In order for a wearable augmented reality device to adequately superimpose information onto reality the following information is needed:
Digital geographic information system database containing the location of objects or points of interest
The instantaneous location of the user
A vector in 3-space describing the view direction of the user. In aeronautical terms this is called roll, pitch and yaw. In navigation terms, it is called bearing, horizon angle, elevation angle
The field of view—where and what the user can see in front of him/her at any given time
Information associated with the objects in view that is desired to be projected
User preferences in terms of what information to display and how to display it
Hardware to manipulate and display the above information consists of:
A display device
One or more user input devices)
Location Sensors (GPS or inertial guidance system or both or other means)
Orientation Sensors
magnetometer, accelerometers, tilt meter
A wearable computer (which may be a smart phone 108 or custom device)
Optionally—a forward (away from the user) video camera for object recognition
Optionally—a rear facing (towards the user) video camera for retinal tracking and/or facial expression monitoring
Optionally—wireless network or web communication

Calculations to be performed in real-time include:
Determine Instantaneous Location of the user/apparatus with one of the following or similar methods which includes:
GPS location
Dead Reckoning based on inertial guidance
Triangulation from Radio signals
Integration and filtering of the above
Determine Instantaneous Orientation
Roll, Pitch, Yaw

Wireless communication can be a critical part of this invention for communication between the display device, the computing device, the various types of input devices.

Examples of Applications that could benefit from a heads up display or augmented reality display are:
Navigation: pedestrian, vehicle, multi-modal
Virtual tour guide
Interactive repair manual
The device with a switchable mirror which is switched on (not oscillating between mirror and clear) could be used to watch movies.

What is claimed:

1. A wearable augmented reality computing apparatus comprising:
a display screen;
a reflective device functionally connected to the display screen such that a user can see the reflection from the display device superimposed on the view of reality;
position and orientation sensors;
a computing device functionally connected to the display device and functionally connected to the position and orientation sensors, said computing device configured to read information from the position and orientation sensors and generate display objects to display on the display screen in an orientation relative to reality calculated base on readings from the position and orientation sensors; and,
a head mounted harness comprising a means to hold the display screen and the reflective device in a position such that the reflection from the display screen is viewable by the user and said head mounted harness is further configured to hold the position and orientation sensors in a fixed position relative to the head of the user of the wearable augmented reality computing apparatus.

2. A wearable augmented reality computing apparatus as claimed in claim 1 wherein:
the reflective device is a switchable mirror functionally connected to the computing device and where the mirror is switched in synchronization with the refresh rate of the portable display screen;
the computing device is further configured to provide a control mechanism which activates the switchable mirror at a frequency sufficient to merge alternate images of reality and the reflection from the portable display into a perceived single image on the eyes and which said switchable mirror is synchronous with the refresh rate of the portable display.

3. A wearable augmented reality computing apparatus as claimed in claim 1 wherein:
the reflective device is a switchable mirror functionally connected to the computing device and where individual pixels of the mirror are switched to be reflective only where augmentation is to be displayed at the location of said pixels;
the computing device is further configured to provide a control mechanism which activates individual pixels on the switchable mirror.

4. A wearable augmented reality computing apparatus as claimed in claim 1 wherein the reflective device is a semi-transparent mirror.

5. A wearable augmented reality computing apparatus as claimed in claim 1 wherein the reflective device is tinted to reduce the ambient light from the reality view.

6. A wearable augmented reality computing apparatus as claimed in claim 1 wherein the computing device is functionally connected to a wireless communication device configured to send and receive information from outside sources which can be displayed on the portable screen.

7. A wearable augmented reality computing apparatus as claimed in claim 1 wherein the computing device and display are contained in a smartphone or a PDA.

8. A wearable augmented reality computing apparatus as claimed in claim 7 that further comprises:
a camera on the side of the smartphone or PDA opposite the portable display screen,
a mirrored prism attached above the camera lense such that light is transmitted from the direction of the gaze of the user.

9. The wearable augmented reality computing apparatus in claim 8 where the computing device is used to calculate route directions for a pedestrian or vehicle and where the directions are displayed on the portable display as a superimposed path on reality.

10. The wearable augmented reality computing apparatus of claim 1 where the means to hold the portable display and the reflective device in a position viewable by the user is attached to the shield of a face mask.

11. The wearable augmented reality computing apparatus of claim 1 where the means to hold the portable display and the reflective device in a position viewable by the user is attached to the visor of a hat.

12. The wearable augmented reality computing apparatus of claim 1 where the means to hold the portable display and the reflective device in a position viewable by the user is functionally attached to a helmet.

13. The wearable augmented reality computing apparatus of claim 1 where the means to hold the portable display and the reflective device in a position viewable by the user is functionally attached to a protective cage.

14. The wearable augmented reality computing apparatus in claim 1 where the head mounted harness further consists of blinders configured to reduce or remove ambient light incident on the eyes coming from anywhere other than through reflective device or reflected from the reflective device.

15. The wearable augmented reality computing apparatus in claim 1 where the reflective device is pivotally attached to the head mounted harness near the edge of the portable display farthest away from the user's face;

16. The wearable augmented reality computing apparatus in claim 1 where the head mounted harness further comprises:
the portable display screen being split into a view for the left eye and a view for the right eye;
an opaque divider between the eyes of the user which only allows light reflected by the reflective device which restricts light from the portable display left eye view to be incident only on the left eye and light from the right eye view to be incident only on the right eye;
the general purpose computing device configured to product a separate display information for each eye.

17. The wearable augmented reality computing apparatus of claim 1 where applications running on the wearable computer device are controlled by the user using input from one or more sensors which can register signals comprising hand gestures, eye movement, brain wave patterns, and voice commands.

18. The wearable augmented reality computing apparatus of claim 1 where the reflective device is operatably attached to the display device and is configured such that is can be removed from the head mounted harness and used as a handheld augmented reality device.

19. The wearable augmented reality computing apparatus of claim 1 further comprising a corrective lense placed between the display device and the reflective device.
